(19) United States
(12) Patent Application Publication
(10) Pub. No.: US 2013/0322981 A1
(43) Pub. Date: Dec. 5, 2013

(54) Tie Down Strap Hook

(71) Applicant: Thomas M. Root, Madison, MS (US)

(72) Inventor: Thomas M. Root, Madison, MS (US)

(73) Assignee: STA-PUT-HOOK, LLC, Madison, MS (US)

(21) Appl. No.: 13/961,331

(22) Filed: Aug. 7, 2013

Related U.S. Application Data
(63) Continuation-in-part of application No. 13/571,894, filed on Aug. 10, 2012.
Application No. 13/571,894 is a continuation-in-part of application No. 13/135,367, filed on Jul. 2, 2011, now abandoned.

(51) Int. Cl. B60P 7/08; F16B 45/00

(52) U.S. Cl. CPC B60P 7/0823; F16B 45/00
USPC 410/97; 410/96

(57) ABSTRACT

A tie-down strap includes a web belt having a first end. A hook is coupled to the web belt at the first end. A first magnet is embedded in the hook. The hook includes a shank portion that terminates in an eye and a bend portion. A bite portion extends from the bend portion. A first magnet is embedded in a selected one of the shank portion and the bite portion.

### CROSS-REFERENCE TO RELATED APPLICATION(S)

This application is a continuation-in-part of, and claims the benefit of, U.S. patent application Ser. No. 13/571,894, filed Aug. 10, 2012, which is a continuation-in-part of, and claims the benefit of U.S. patent application Ser. No. 13/135,367 filed Jul. 2, 2011, now abandoned, the entirety of each of which is hereby incorporated herein by reference.

### BACKGROUND OF THE INVENTION

1. Field of the Invention

The present invention relates to hooks that terminate the end of tie down straps and, more specifically, to a hook that includes a magnetic portion.

2. Description of the Related Art

Conventional grab hooks have been available in their present form for many decades and are currently available in a variety of sizes and connector configurations. Grab hooks are typically connected to heavy duty chains that are used to secure, lift, or move heavy loads. The specification refers to the use of such hooks with chains. However, “chain” may refer to any type of securement including but not limited to chains, cables, ropes, straps, and wires, etc. Often, one person uses such chains for these purposes. Because of the strength and durability requirements for such jobs, grab hooks are typically cast or forged with high-strength steel alloys that are ferromagnetic or austenitic. Chains are typically made of a ferromagnetic material.

Typically, the proximal end of the grab hook is attached to the distal end link in a chain, often with a clevis and pin type connection. The distal end of a grab hook has an elongated slot-shaped throat that is sized to accommodate any intermediate link in the attached chain without permitting the either of the adjacent links in the chain to slide through the throat of the hook. Therefore, once the open end of a grab hook is engaged with a chain, the chain will not slide in the hook.

However, the slot-shaped opening in a typical grab hook remains open and will permit an engaged link of a chain to fall out of the hook. The chain is particularly susceptible to falling out of the grab hook before tension is applied to the chain or if tension in the chain is released. This leads to a particularly difficult problem when one person is using the chain because the first end of the chain falls off the hook before the other end is secured causing the user to have to reattach the first end and hope that it stays in place. One solution is for the user of the chain to get assistance from a helper who holds the grab hook in place while the user applies tension to the chain. Another solution that is sometimes used when a helper is not available is for the user of the chain to tie a knot in the chain rather than using the hook. This approach is not preferred and sometimes even dangerous because knots in chains are notoriously unreliable when high tension loads are applied to the chain. Commercial users of chains straps or cables, e.g., truckers, loggers and construction workers need grab hooks that will stay in place on the chain or cable until tension can be applied to the chain, strap or cable.

To address this problem in the past, grab hooks have been fitted with latches to dose the open end after the grab hook engages the chain. One such grab hook is described, for example, in U.S. Pat. No. 6,019,408. Such latches are sometimes spring loaded and come in a wide variety of configurations. However, latch mechanisms add complexity to the grab hook which can require additional steps to engage the grab hook with the chain. Some of such latches can be difficult to open and dose, especially when the user is wearing protective gloves. Such latches may also break during use, at least rendering the latch inoperative and perhaps interfering with the normal use of the grab hook itself.

Tie-down straps are commonly used for securing objects being transported to the vehicles transporting them. Typical tie-down straps include a nylon web belt in which each end terminates in a hook for securing the belt to the vehicle. A ratcheting mechanism may be used to tighten the strap. Frequently, users of tie-down straps become frustrated while securing the straps to the connection points on vehicles because one end often gets pulled away from a connection point when the user is trying to secure the other end to a different connection point.

Therefore, there is a need for a tie-down strap with a hook that tends to stay in place prior to the final securing of the tie-down strap.

### SUMMARY OF THE INVENTION

The grab hooks described in this document include a magnetic portion near the distal end of the hook that is positioned to magnetically engage at least one link in a chain when another link of the chain is positioned in the throat of the hook. The magnetic connection between the grab hook and the chain prevents the chain from falling out of the throat while the chain is slack. The magnetic connection thus permits the user of the chain to position the other end of the slack chain and apply tension to the chain to secure the chain in its operative position, for example, for securing, towing, or lifting a load. The grab hook described has no latches or other moving parts for securing the slack chain in the throat of the grab hook, Therefore, the described grab hook is simpler to operate than conventional grab hooks with latches to dose the throat.

The disadvantages of the prior art are overcome by the present invention which, in one aspect, is a tie-down strap that includes a web belt having a first end. A hook is coupled to the web belt at the first end. A first magnet is embedded in the hook.

In another aspect, the invention is a hook for use with a tie-down strap that includes a shank portion that terminates in an eye and a bend portion. A bite portion extends from the bend portion. A first magnet is embedded in a selected one of the shank portion and the bite portion.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a generally illustrates one exemplary use of a chain with a grab hook according to the present invention to secure cargo to a flatbed trailer.

FIG. 2 is a generally illustrates cargo that is secured using the chain and grab hook shown in FIG. 1.

FIG. 3 is a is an exploded perspective view of one embodiment of a grab hook with an embedded magnet according to the invention, a chain that is compatible with the grab hook, and a clevis pin used to secure the grab hook to the chain.

FIG. 4 is a is a detailed perspective view of the grab hook shown in FIGS. 1 and 3 that illustrates the manner in which the embedded magnet in the grab hook engages a link in a chain.

FIG. 5 is a front elevation view of the grab hook shown in FIG. 3.

FIG. 6 is a side elevation view of the grab hook shown in FIG. 3.

FIG. 7 is a top elevation view of the grab hook shown in FIG. 3.

FIG. 8 is a side elevation view of an alternative embodiment of a grab hook according to the invention.

FIG. 9 is a sectional view of the alternative embodiment of the grab hook shown in FIG. 8.

FIG. 10A is a schematic plan view of an embodiment configured to secure a tie-down strap.

FIG. 10B is a cross-sectional view of the embodiment shown in FIG. 10A, taken along line 10B-10B.

FIG. 10C is a schematic elevational view of the embodiment shown in FIG. 10A employed with a web belt.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

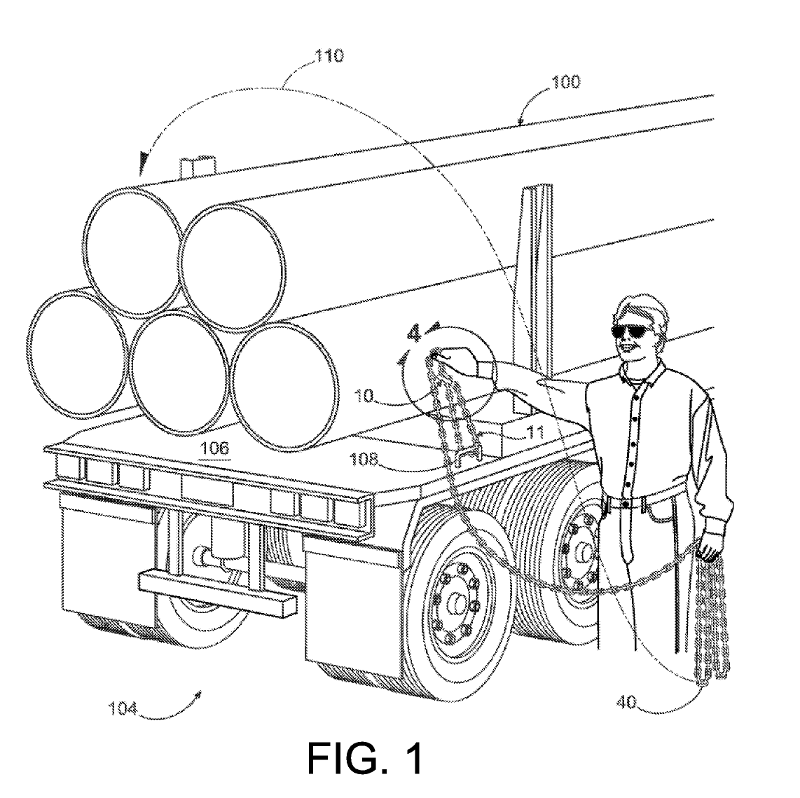

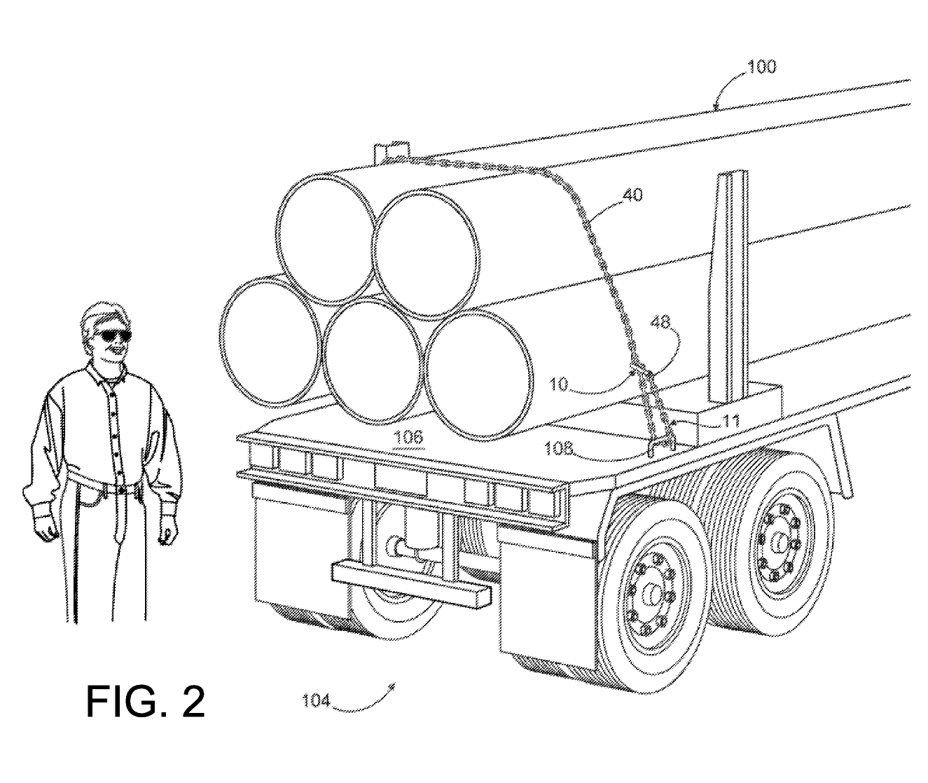

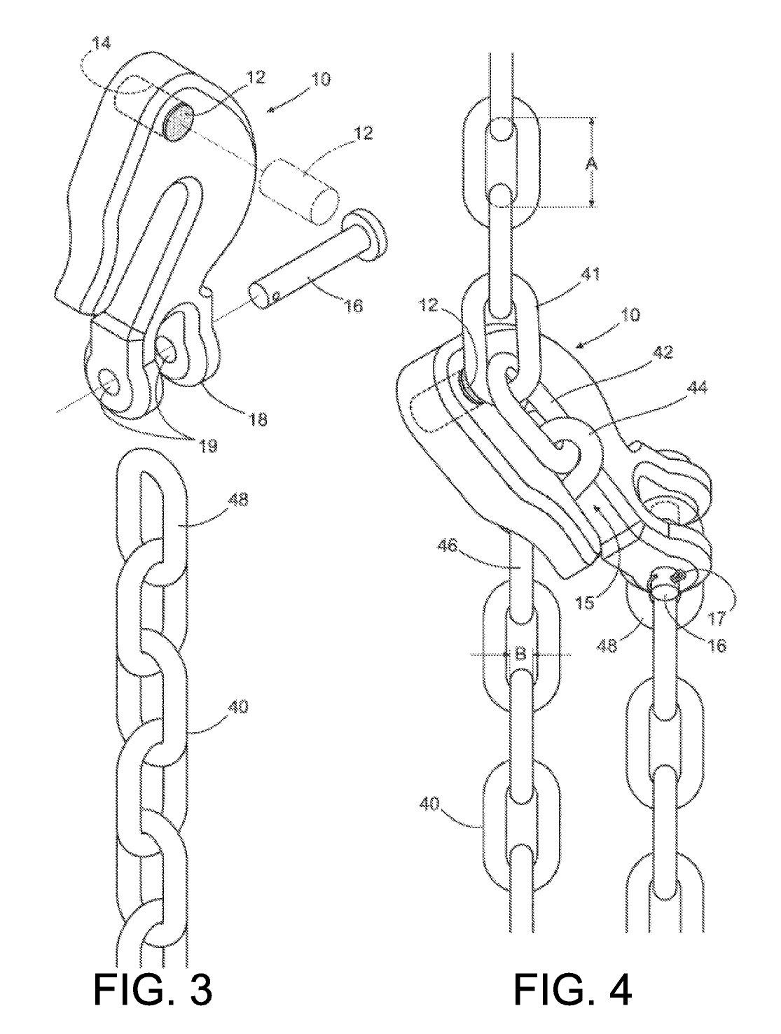

FIGS. 1 and 2 generally illustrate one exemplary use of a chain 40 with a grab hook 10 according to the present invention to secure cargo 100 to the bed 106 of a flatbed trailer 104. The proximal end of grab hook 10 is connected to link 48 at one distal end of chain 40 (see FIGS. 3 and 4). The user inserts the grab hook 10 and chain 40 through cleat 108 which is attached to bed 106 to form a loop 11 in chain 40.

As shown in FIG. 4, an intermediate link 44 is positioned in throat 15 of grab hook 10 Links 42 and 46, which are adjacent to link 44 prevents link chain 10 from sliding through throat 15. Chain 40 as shown in the drawings must include at least one ferromagnetic link 41, which is attracted to and engages with magnet 12, which prevents link 44 from falling out of throat 15 while tension is not applied to the opposite end of the chain. The ferromagnetic link in chain 40 may any or all links in the chain so long as at least one link is ferromagnetic and capable of being magnetically engaged by magnet 12. When link 44 is positioned in throat 15 of grab hook 10 and link 41 is engaged with magnet 12, the user can throw the opposite end of chain 40 along path 110 to the other end of cargo 100. The engagement of link 41 with magnet 12 prevents the grab hook 10 from falling out of engagement with link 44 of chain 40. Once the chain 40 is positioned as shown in FIG. 2, and the opposite end of chain 40 is secured to a cleat on the other side of bed 106, then tension can be applied to chain 40 to secure cargo 100 to bed 106.

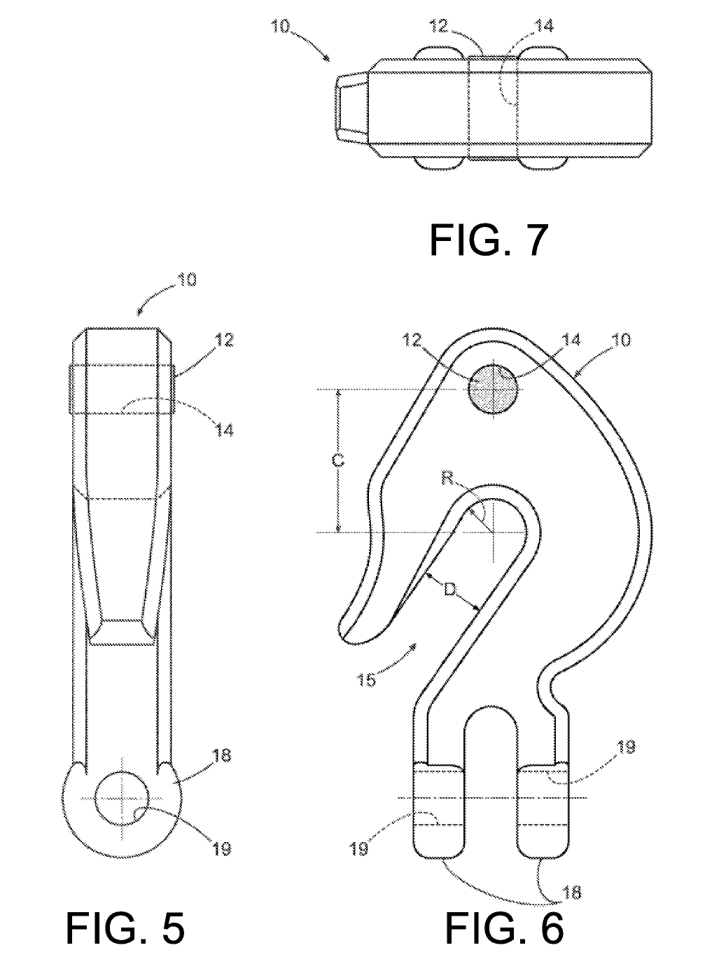

FIGS. 3 and 5-7 illustrate details of grab hook 10 with an integrated magnet 12, a chain 40 that is compatible with grab hook 10, and a clevis pin 16 used to secure grab hook 10 to distal link 48 in chain 40. Clevis 18 includes bores 19 that are sized to accept clevis pin 16. The space in clevis 18 is sized to accept the end of link 48. Once link 48 is positioned in the opening of clevis 18, clevis pin 16 is inserted through bores 19 and the interior opening of link 48. Cotter pin 17 secures clevis pin 16 in this position so that grab hook 10 is securely fastened to link 48. The distal portion of grab hook 10 is extended distally as compared to conventionally shaped grab hooks to add strength to grab hook 10 despite the presence of bore 14. Magnet 12 is illustrated as a cylindrical magnet that is sized to form an interference fit inside bore 14 in the distal portion of grab hook 10.

FIG. 4 illustrates the manner in which magnet 12 engages link 41 in chain 40 when link 44 is positioned in throat 15 of grab hook 10. Interference between throat 15 and links 42 and 46, which are adjacent to link 44, prevents chain 40 from sliding along the length of the chain through throat 15 of grab hook 10. The magnetic engagement between magnet 12 at the top portion of grab hook 10 and link 41 prevents link 44 from inadvertently falling out of throat 15. Each link in chain 40 has an inside length A and a link diameter B. Rare-earth magnets such as those formed with neodymium or samarium-cobalt alloy are the preferred materials for magnet 12. However, any permanent magnet including but not limited to alnico and ferrite magnets with sufficient magnetic field strength to hold chain 40 in throat 15 is acceptable.

As shown in FIG. 6, throat 15 has a width D that is slightly larger than link diameter B so that throat portion can accommodate links in the chain and hold the engaged link in a reasonably secure manner. Throat 15 includes one open end and an arc-shaped portion at the other end in which the arc-shaped portion is defined by a radius R measured from an origin. The magnet 12 is preferably located in a position that is offset from the origin of radius R by a distance C. Distance C is preferably about the same as inside length A (see FIG. 4) of each link in chain 40. For example, the difference between distance C and inside length A should be maintained so that magnet 12 engages some portion of a link (e.g., link 41) that is the second link distant from the link (e.g., link 44) that is engaged in throat 15, Distance C is preferably between approximately 80% and 200% of inside length A to enable link 41 to engage magnet 12. However, any distance C that permits at least one link of chain 40 to engage magnet 12 is permitted.

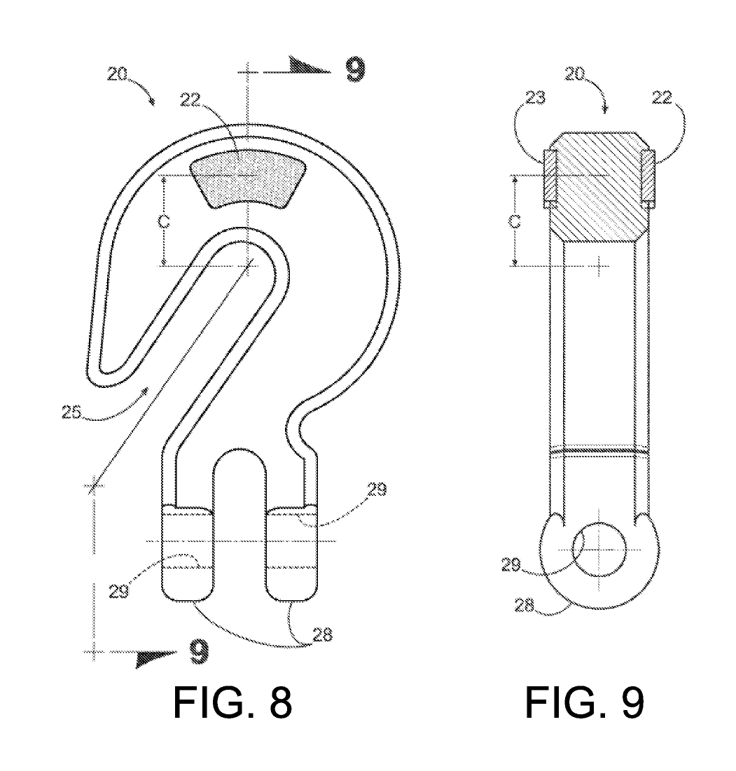

FIGS. 8 and 9 illustrate grab hook 20, which is an exemplary alternative embodiment of a grab hook according to the invention. Grab hook 20 includes two magnets 22 and 23 that are generally arc-shaped slabs and embedded in opposing cut out portions on the sides of the distal portion of grab hook 20. Shapes other than arc-shaped slabs may be substituted for magnets 22 and 23 so long as the magnets provide enough surface area to engage chain 40. Grab hook 20 includes throat 25 and clevis 28 at the proximal end with bores 29. Clevis 28 of grab hook 20 would attach to distal link 48 of chain 40 in the same way as clevis 18 of grab hook 10. The cut out portions for magnets 22 and 23 are sufficiently shallow so they do not compromise the load bearing capacity of grab hook 20 and they allow magnets 22 and 23 to protrude slightly from the side surfaces of grab hook 20. Dimension C of grab hook 20 is shorter than dimension C of grab hook 10. However, it is still sized to permit at least one link of chain 40 to engage magnetically with either magnet 22 or magnet 23 when another link (e.g., link 44) is engaged in throat 25 of grab hook 20. The same materials that are preferred for magnet 12 are also preferred for magnets 22 and 23.

It will be apparent to those skilled in the art that various modifications and variations can be made in the grab hook of the present invention and in the construction of the grab hook without departing from the scope or spirit of the invention. For example, the grab hook 10 has been described in connection with chain 40. However, any hook with a magnet positioned in the distal portion of the hook combined with any type of long securement such as a cable, rope, or strap with a ferrous portion capable of engaging with the magnet in the hook can exhibit the advantages of the exemplary combinations of hooks and chains described above.

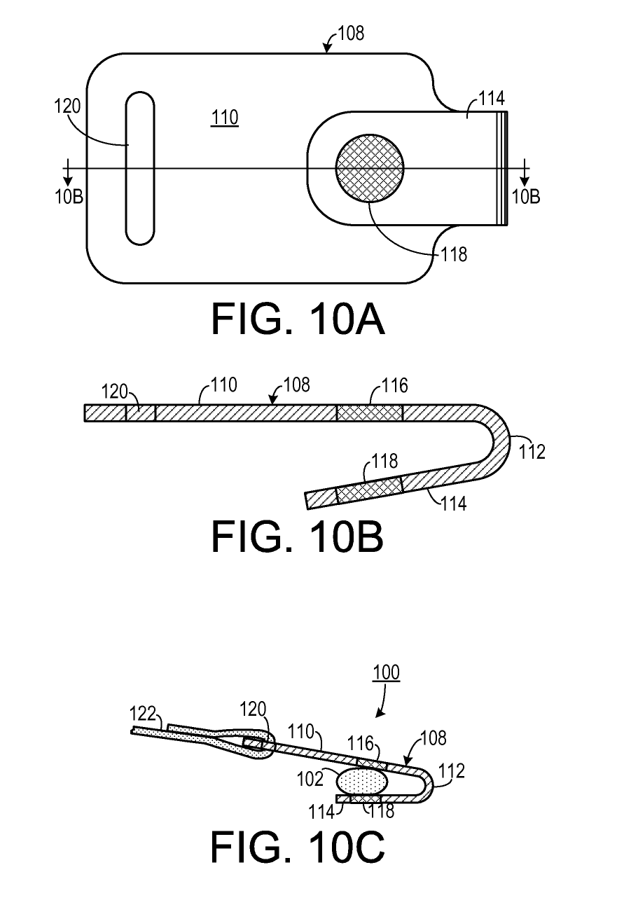

As shown in FIGS. 10A-10C a tie-down strap 100 includes a web belt 122 having a first end. A hook 108 is coupled to the web belt 122 at the first end. The hook 108 includes a shank portion 110 terminating in an eye 120 through which the web belt 122 is secured to the hook 108. The hook 108 also includes a bend portion 112 spaced apart from the eye 120 and a bite portion 114 that extends from the bend portion 112.

One or more magnets (such as rare earth magnets) can be embedded in the hook 110. For example, a first magnet 116 can be embedded in the shank portion 110 and a second magnet 118 can be embedded in the bite portion. Typically, the magnets 114 and 116 are press fit into holes drilled in the hook 110. The magnets 116 and 118 can be used to hold the hook 110 against ferrous surfaces 102 when the tie down strap 100 is being placed prior to its being secured.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A tie-down strap, comprising:
(a) a web belt having a first end;
(b) a hook coupled to the web belt at the first end; and
(c) a first magnet embedded in the hook.

2. The tie-down strap of claim 1, wherein the first magnet comprises a rare earth magnet.

3. The tie-down strap of claim 1, wherein the hook comprises:
(a) a shank portion terminating in an eye through which the web belt is secured to the hook at one end and a bend portion at a second end; and
(b) a bite portion extending from the bend portion.

4. The tie-down strap of claim 3, wherein the first magnet is embedded in the bite portion.

5. The tie-down strap of claim 4, further comprising a second magnet that is embedded in the shank portion.

6. The tie-down strap of claim 5, wherein the second magnet comprises a rare earth magnet.

7. The tie-down strap of claim 3, wherein the first magnet is embedded in the shank portion.

8. The tie-down strap of claim 3, wherein the shank portion defines a hole passing therethrough and wherein the first magnet is disposed within the hole.

9. The tie-down strap of claim 3, wherein the bite portion defines a hole passing therethrough and wherein the first magnet is disposed within the hole.

10. A hook for use with a tie-down strap, comprising:
(a) a shank portion terminating in an eye at a first end and a bend portion at a second end;
(b) a bite portion extending from the bend portion; and
(c) a first magnet embedded in a selected one of the shank portion and the bite portion.

11. The hook of claim 10, wherein the shank portion defines an eye.

12. The hook of claim 11, further comprising a web belt that is secured to the hook through the eye.

13. The hook of claim 10, wherein the first magnet comprises a rare earth magnet.

14. The hook of claim 10, wherein the first magnet is embedded in the bite portion.

15. The hook of claim 14, further comprising a second magnet that is embedded in the shank portion.

16. The hook of claim 15, wherein the second magnet comprises a rare earth magnet.

17. The hook of claim 10, wherein the first magnet is embedded in the shank portion.

18. The hook of claim 10 wherein the shank portion defines a hole passing therethrough and wherein the first magnet is disposed within the hole.

19. The hook of claim 10, wherein the bite portion defines a hole passing therethrough and wherein the first magnet is disposed within the hole.
